(19) United States
(12) Patent Application Publication
(10) Pub. No.: US 2012/0107638 A1
(43) Pub. Date: May 3, 2012

(54) SILVER INLAID PRODUCT AND A PRODUCTION METHOD THEREFOR

(76) Inventor: Moon Hyun Lee, Seoul (KR)

(21) Appl. No.: 13/382,329

(22) PCT Filed: Jul. 9, 2009
(86) PCT No.: PCT/KR09/03767

§ 371 Date: Jan. 5, 2012

(51) Int. Cl. B32B 15/01; B44C 1/22; B44C 3/00

(52) U.S. Cl. 428/614; 29/530

(57) ABSTRACT

Disclosed is a silver inlaid product and a method of manufacturing the silver inlaid product, in which silver having the aesthetic appeal and the sterilizing ability is inlaid into metal, such as stainless steel and brass, having the durability and convenience in use, to provide tableware having the property of both metal and silver. method of inlaying silver includes: a first step of preliminarily processing stainless steel into a stainless steel plate according to a shape of a finished product; a second step of engraving a top surface of the preliminarily processed stainless steel plate in a shape for inlaying silver to form an engraved part; a third step of inlaying silver into the engraved part to form a preliminarily inlaid part; a fourth step of pressing the top surface in which the inlaid part is formed and welding the silver; a fifth step of flattening processing the top surface of the stainless steel plate and removing the silver protruding beyond the stainless steel plate; a sixth step of bending processing the flattening processed stainless steel plate in one direction; and a seventh step of polishing processing the top surface of the bending processed stainless steel plate.

### TECHNICAL FIELD

The present invention relates to a silver inlaid product and a method of producing the silver inlaid product, and more particularly to technology for providing spoons and chopsticks, tableware, household items, etc., which have both the durability and convenience in use of stainless steel or brass and the aesthetic appeal and the sterilizing ability of silver.

### BACKGROUND ART

Tableware, such as spoons, chopsticks, plates, and bowls, is made of various materials, such as wood, ceramic, brass, glass, silver, and stainless steel.

Among them, tableware made of silver has not only a luxurious appearance due to the unique luster of silver but also a functionality of the sterilizing ability of silver.

However, silver is expensive and becomes black as time goes by, so it is inconvenient to manage the table ware made of silver.

In the meantime, the stainless steel contains nickel, tungsten, vanadium, copper, silicon, etc. depending on a usage, in addition to chrome and carbon, so it has an excellent strength and is not rusted, to have an advantage of easy management. However, the tableware made of stainless steel has a problem of failing to achieve a luxurious appearance and a sterilizing ability.

Further, the tableware made of brass, which is a copper alloy, has an excellent durability, but has a problem of failing to achieve a luxurious appearance and a sterilizing ability.

In order to solve the aforementioned problems, a product having a stainless steel surface plated with silver has been suggested.

A silver plated product reduces a manufacturing expense due to the usage of a small amount of silver and has a luxurious appearance. However, the surface of silver becomes black as time goes by, so it fails to overcome a problem of the inconvenient management, and further silver may be peeled off, so the appearance of the silver plated product is deteriorated.

In the meantime, household items, such as a hand mirror, have much contact with a hand of a user, to become polluted and have an insanitary part.

### DISCLOSURE

### Technical Problem

Accordingly, an object of the present invention has been made to solve the above-mentioned problems occurring in the prior art, and the present invention provides a silver inlaid product and a method of producing the silver inlaid product having a high durability, management convenience, and a luxurious appearance.

### Technical Solution

In accordance with an aspect of the present invention, there is provided a silver inlaid product including: a main body made of a metal material having a high durability or management convenience and having an engraved part for inlaying of silver; and a silver inlaid part formed by inlaying silver into the engraved part so as to provide a luxurious appearance or a sterilizing ability.

Preferably, a width of the silver inlaid part increases as it becomes farther away from a top surface to a lower surface of the main body such that the silver inlaid part is prevented from being separated from the engraved part during usage, the silver inlaid part is concavely bent from the top surface to the lower surface of the main body based on the top surface of the main body such that a width of a lower surface of the silver inlaid part is larger than a width of a top surface of the silver inlaid part.

Preferably, the engraved part is formed in a convex surface formed by convexly bending the main body in an upper direction such that a width of a lower surface of the silver inlaid part is larger than a width of a top surface of the silver inlaid part, and the silver inlaid part formed by inlaying the silver into the engraved part is flattening processed.

Preferably, a width of a lower surface of the engraved part is larger than a width of a top surface of the engraved part such that a width of a lower surface of the silver inlaid part is larger than a width of a top surface of the silver inlaid part, and the silver inlaid part is formed by inlaying silver into the engraved part.

Preferably, the metal material forming the main body includes stainless steel or brass, and the silver inlaid into the engraved part includes at least one of silver wire, silver powder, and silver liquid.

In accordance with another aspect of the present invention, there is provided a method of inlaying silver into a surface of a product, the method including: preliminarily processing a main material to have a shape of a finished product; forming an engraved part by engraving a shape for inlaying silver on one surface of a preliminarily processed product; and forming a silver inlaid part by filling the engraved part with silver and pressing the engraved part.

Preferably, forming of the silver inlaid part includes concavely bending the silver inlaid part from a top surface to a lower surface of a main body based on the top surface of the main body such that a width of the silver inlaid part increases as it becomes farther away from the top surface to the lower surface of the main body.

Preferably, forming of the engraved part includes: convexly bending the engraved part to an upper direction from a top surface of a main body based on the top surface of the main body such that a width of the silver inlaid part increases as it becomes farther away from the top surface to a lower surface of the main body; and flattening the silver inlaid part formed by inlaying the silver into the convexly bent engraved part.

Preferably, in forming of the engraved part, a width of a lower surface of the engraved part is formed to be larger than a width of a top surface of the engraved part such that a width of a lower surface of the silver inlaid part is larger than a width of a top surface of the silver inlaid part.

Preferably, the metal material forming the main body includes stainless steel or brass, and the silver inlaid into the engraved part includes at least one of silver wire, silver powder, and silver liquid.

### Advantageous Effects

Accordingly, the present invention can provide a silver inlaid product and a method of producing the silver inlaid product, which uses a stainless steel plate and brass as main materials, thereby reducing a production expense and achieving an excellent strength, and inlays a surface with silver, thereby achieving a luxurious appearance and a sterilizing effect.

### BRIEF DESCRIPTION OF THE DRAWINGS

The above and other objects, features and advantages of the present invention will be more apparent from the following detailed description taken in conjunction with the accompanying drawings, in which:

FIG. 1 is a flowchart illustrating a method of inlaying silver according to a first embodiment of the present invention;

FIG. 2 is a perspective view illustrating a preliminarily processed stainless steel plate according to a first embodiment of the present invention;

FIG. 3 is a cross-sectional view illustrating a stainless steel plate including an engraved part according to a first embodiment of the present invention;

FIG. 4 is a cross-sectional view illustrating a state in which silver is preliminarily inlaid according to a first embodiment of the present invention;

FIG. 5 is a cross-sectional view illustrating a state in which silver is welded according to a first embodiment of the present invention;

FIG. 6 is a cross-sectional view illustrating a state in which a stainless steel plate is flattening processed according to a first embodiment of the present invention;

FIG. 7 is a cross-sectional view illustrating a state in which a stainless steel plate is bending processed according to a first embodiment of the present invention;

FIG. 8 is a cross-sectional view illustrating a stainless steel plate including an engraved part according to a second embodiment of the present invention;

FIG. 9 is a cross-sectional view illustrating a state in which a stainless steel plate is bending processed according to a second embodiment of the present invention; and

FIG. 10 is a flowchart illustrating a method of inlaying silver according to a third embodiment of the present invention.

<Description of references of main parts in drawings>

| | |
|---|---|
| 100: spoon | 110: stainless steel plate |
| 120: silver inlaid part | |
| 150: plate for forming engraved part | |
| 160: pressing plate | |

### BEST MODE

Hereinafter, an embodiment of the present invention will be described with reference to the accompanying drawings. Further, in the following description of the present invention, a detailed description of known functions and configurations incorporated herein will be omitted when it may make the subject matter of the present invention rather unclear. Further, the terms used in the description are defined considering the functions of the present invention and may vary depending on the intention or usual practice of a user or operator. Therefore, the definitions should be made based on the entire contents of the description.

Hereinafter, the present invention will be described based on an example that a metal material forming a main body is a stainless steel, but the present invention is not limited thereto, and may use other metals, such as brass. Further, inlaid silver is described on a basis of a silver wire, but silver powder or silver liquid may be used as a matter of course.

### First Embodiment

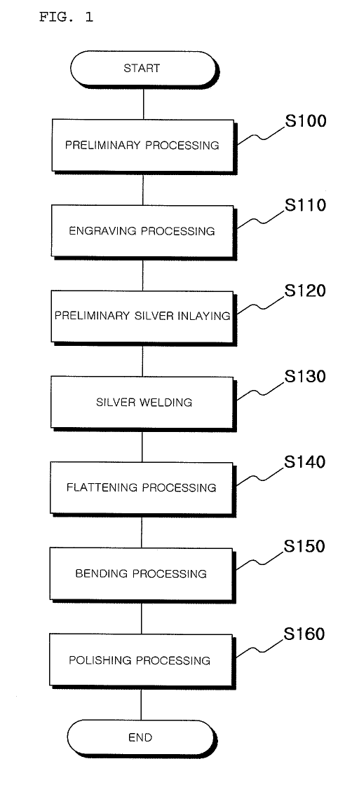

A first embodiment of the present invention will be described with accompanying drawings, FIGS. 1 to 7.

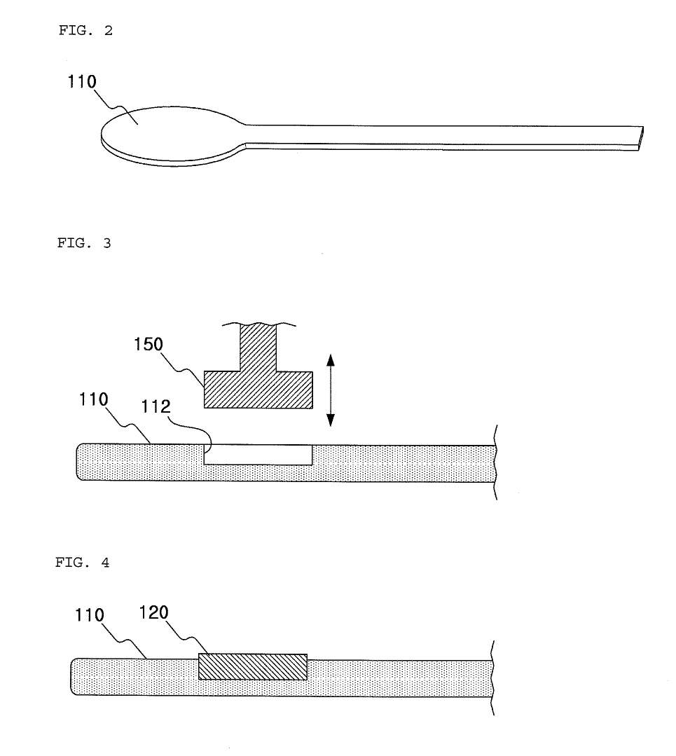

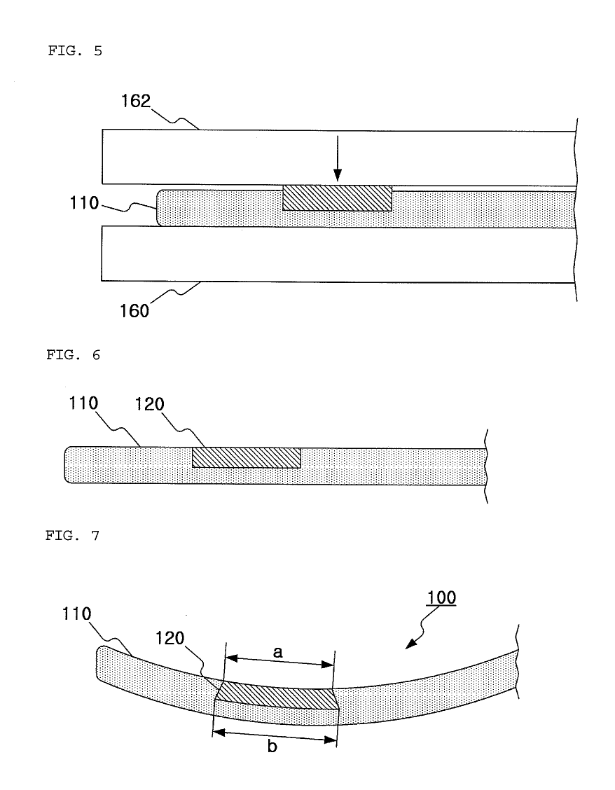

FIG. 1 is a flowchart illustrating a method of inlaying silver according to a first embodiment of the present invention, FIG. 2 is a perspective view illustrating a preliminarily processed stainless steel plate according to a first embodiment of the present invention, FIG. 3 is a cross-sectional view illustrating a stainless steel plate including an engraved part according to a first embodiment of the present invention, FIG. 4 is a cross-sectional view illustrating a state in which silver is preliminarily inlaid according to a first embodiment of the present invention, FIG. 5 is a cross-sectional view illustrating a state in which silver is welded according to a first embodiment of the present invention, FIG. 6 is a cross-sectional view illustrating a state in which a stainless steel plate is flattening processed according to a first embodiment of the present invention, and FIG. 7 is a cross-sectional view illustrating a state in which a stainless steel plate is bending processed according to a first embodiment of the present invention.

As illustrated in FIG. 1, in the method of inlaying the silver according to the first embodiment of the present invention, seven steps, i.e. a preliminary processing, an engraving processing, a preliminary silver inlaying, a silver welding, a flattening processing, a bending processing, and a polishing processing, are sequential performed for stainless steel.

In the first step S100, stainless steel is preliminarily processed into a stainless steel plate 110 according to a shape of a finished product, the state of which is illustrated in FIG. 2. As illustrated in FIG. 2, a silver inlaid spoon is produced in the first embodiment of the present invention, so the stainless steel plate 110 is processed so as to entirely have a spoon shape. The present invention is not necessarily limited to the spoon, and may be variously applied to the production of tableware including chopsticks, cups, plates, and bowls and other household items including a hand mirror.

In the second step S110, a top surface of the preliminarily processed stainless steel plate 110 is engraved in a shape for inlaying of silver to form an engraved part 112.

Here, it is preferable that the engraved part is formed by punching the stainless steel plate 110 with a frame 150 embossed in a shape for the inlaying of silver in a heated state of the stainless steel plate 110 and forming the engraved part 112 at the stainless steel plate 110.

In this case, a temperature for heating the stainless steel plate 110 is preferably lower than that of a melting point of the stainless steel plate, and the temperature may be changed according to a combination of materials of the stainless steel. The state of the second step S110 is illustrated in FIG. 3.

In the third step S120, the engraved part 112 is filled with silver so that a preliminarily inlaid part 120 is formed. It is preferable to form the preliminarily inlaid part 120 by filling the engraved part 112 with silver wires having a quadrangle cross section, the state of which is illustrated in FIG. 4.

In the fourth step S130, a top surface in which the inlaid part 120 is formed is pressed and silver is welded. Here, it is preferable to weld the silver by pressing in a state where the heated stainless steel plate 110 is positioned between pressing plates 160 and 162 having the same curvature as a surface curvature of the stainless steel plate 110. The heating temperature of the stainless steel plate 110 is preferably lower than a melting point of silver. The state of the fourth step S130 is illustrated in FIG. 5. Through the fourth step S130, the engraved part 112 is fully filled with silver

In the fifth step S140, the top surface of the stainless steel plate 110 is flattening processed, to remove silver protruding beyond the stainless steel plate 110, the state of which is illustrated in FIG. 6. Accordingly, the stainless steel plate 110 comes to have a smooth surface state.

In the sixth step S150, the flattening processed stainless steel plate 110 is bending processed in one direction. A bending direction in which the silver inlaid surface becomes concave and an opposite surface thereof becomes convex is preferable, the state of which is illustrated in FIG. 7. As illustrated in FIG. 7, a width b of the silver inlaid part in a deep region is larger than a width a of the silver inlaid part in a top surface side, so that it is possible to prevent the silver inlaid part 120 from being separated from the stainless steel plate 110 due to impact or vibration during the usage.

In the seventh step S160, the surface of the bent stainless steel plate 110 is polishing processed. Through the above steps, a spoon 100 including the silver inlaid part 120 formed in the stainless steel plate 110 is completed.

In the meantime, the silver wire is inlaid in the present embodiment. However, it is possible to inlay silver using silver powder or silver liquid, and in this case, the fifth step, etc. may be omitted.

### Mode for Invention

### Second Embodiment

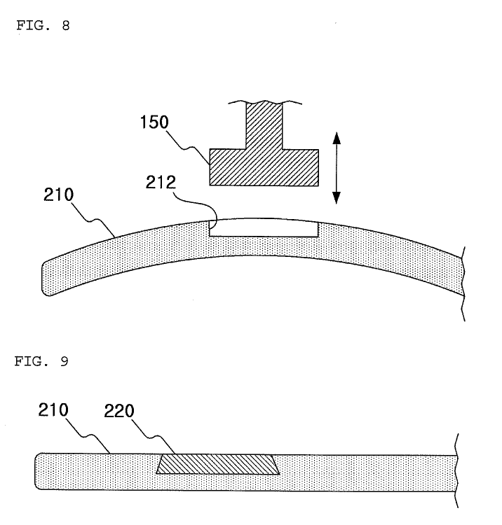

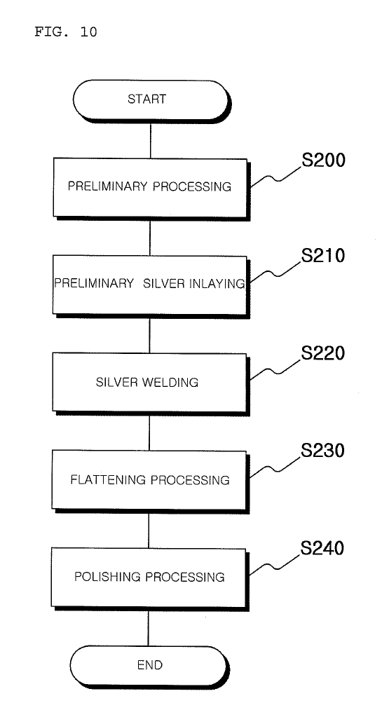

Hereinafter, a second embodiment of the present invention will be described with reference to accompanying drawings, FIGS. 8 and 9.

FIG. 8 is a cross-sectional view illustrating a stainless steel plate including an engraved part according to a second embodiment of the present invention, and FIG. 9 is a cross-sectional view illustrating a state in which a stainless steel plate is bending processed according to a second embodiment of the present invention.

As illustrated in FIGS. 8 and 9, a stainless steel plate 210 according to the second embodiment is actually identical to the stainless steel plate 110 according to the first embodiment, except that a top surface of the stainless steel plate 210 in which an engraved part 212 is formed is convexly bent before the bending processing and becomes in a flat state after the bending processing.

Through the second embodiment, it can be identified that the silver inlaying may be applied even to a finished product in a flat state. Further, through a combination of the first embodiment and the second embodiment, the silver inlaying may be applied even to a finished product including both a bent part and a flat part.

### Third Embodiment

Hereinafter, a third embodiment of the present invention will be described with reference to accompanying drawing, FIG. 10.

FIG. 10 is a flowchart illustrating a method of inlaying silver according to a third embodiment of the present invention.

As illustrated in FIG. 10, in the method of inlaying silver according to the third embodiment of the present invention, in a first step, an engraved part is formed by engraving a top surface of a stainless steel plate in a shape for inlaying of silver, and an area of the engraved part increases as it becomes farther away from the top surface of the stainless steel plate (S200).

In a second step, the engraved part is filled with the silver to form a preliminarily inlaid part (S210).

In a third step, a top surface in which the preliminarily inlaid part is formed is pressed and the silver is welded (S220).

In a fourth step, the surface of the stainless steel plate is flattening processed, so that the silver protruding beyond the stainless steel plate is removed (S230).

In a fifth step, the flattening processed surface of the stainless steel plate is polishing processed (S240).

As can be seen through the above steps, the method of inlaying silver according to the third embodiment of the present invention is characterized in that the engraved part is simultaneously formed at the time of the preliminary processing of the stainless steel plate, and the area of the engraved part increases as it becomes farther away from the surface of the stainless steel part such that the silver inlaid part is not separated from the stainless steel plate even without the bending processing.

### INDUSTRIAL APPLICABILITY

Although the embodiments of the present invention has been described with reference to the accompanying drawing through the above description, the present invention is not specially limited to the described embodiments, and those skilled in the art will appreciate that various modifications and changes are possible within the scope and spirit of the invention as disclosed in the accompanying claims according to the necessity.

1. A silver inlaid product comprising:
a main body made of a metal material having a high durability or management convenience and having an engraved part for inlaying of silver; and
a silver inlaid part formed by inlaying silver into the engraved part so as to provide a luxurious appearance or a sterilizing ability.

2. The silver inlaid product as claimed in claim 1, wherein a width of the silver inlaid part increases as it becomes farther away from a top surface to a lower surface of the main body such that the silver inlaid part is prevented from being separated from the engraved part during usage.

3. The silver inlaid product as claimed in claim 2, wherein the silver inlaid part is concavely bent from the top surface to the lower surface of the main body based on the top surface of the main body such that a width of a lower surface of the silver inlaid part is larger than a width of a top surface of the silver inlaid part.

4. The silver inlaid product as claimed in claim 2, wherein the engraved part is formed in a convex surface formed by convexly bending the main body in an upper direction such that a width of a lower surface of the silver inlaid part is larger than a width of a top surface of the silver inlaid part, and the silver inlaid part formed by inlaying the silver into the engraved part is flattening processed.

5. The silver inlaid product as claimed in claim 2, wherein a width of a lower surface of the engraved part is larger than a width of a top surface of the engraved part such that a width of a lower surface of the silver inlaid part is larger than a width of a top surface of the silver inlaid part, and the silver inlaid part is formed by inlaying silver into the engraved part.

6. The silver inlaid product as claimed in claim 1, wherein the metal material forming the main body includes stainless steel or brass, and the silver inlaid into the engraved part includes at least one of silver wire, silver powder, and silver liquid.

7. A method of inlaying silver into a surface of a product, the method comprising:
preliminarily processing a main material to have a shape of a finished product;
forming an engraved part by engraving a shape for inlaying silver on one surface of a preliminarily processed product; and
forming a silver inlaid part by filling the engraved part with silver and pressing the engraved part.

8. The method as claimed in claim 7, wherein forming of the silver inlaid part comprises concavely bending the silver inlaid part from a top surface to a lower surface of a main body based on the top surface of the main body such that a width of the silver inlaid part increases as it becomes farther away from the top surface to the lower surface of the main body.

9. The method as claimed in claim 7, wherein forming of the engraved part comprises:
convexly bending the engraved part to an upper direction from a top surface of a main body based on the top surface of the main body such that a width of the silver inlaid part increases as it becomes farther away from the top surface to a lower surface of the main body; and
flattening the silver inlaid part formed by inlaying the silver into the convexly bent engraved part.

10. The method as claimed in claim 7, wherein in forming of the engraved part, a width of a lower surface of the engraved part is formed to be larger than a width of a top surface of the engraved part such that a width of a lower surface of the silver inlaid part is larger than a width of a top surface of the silver inlaid part.

11. The method as claimed in one of claim 7, wherein the metal material forming the main body includes stainless steel or brass, and the silver inlaid into the engraved part includes at least one of silver wire, silver powder, and silver liquid.
